(19) United States
(12) Patent Application Publication
(10) Pub. No.: US 2022/0178394 A1
(43) Pub. Date: Jun. 9, 2022

(54) SYSTEMS AND METHODS FOR CONNECTING FLOTATION DEVICES

(71) Applicant: Kelli Johnson, Washington, DC (US)

(72) Inventor: Kelli Johnson, Washington, DC (US)

(21) Appl. No.: 17/546,798

(22) Filed: Dec. 9, 2021

Related U.S. Application Data
(60) Provisional application No. 63/122,998, filed on Dec. 9, 2020.

(51) Int. Cl. F16B 2/10

(52) U.S. Cl. CPC F16B 2/10

(57) ABSTRACT

In an example, a connection system for securing a flotation device is described. The system comprises a clamp configured to connect to the flotation device, a line length adjuster comprising a line, where the line length adjuster is configured to adjust a length of the line to a given length, and a connector configured to couple the clamp to the line length adjuster.

### CROSS-REFERENCE TO RELATED APPLICATIONS

This application claims the benefit of priority under 35 U.S.C. § 119 to U.S. Provisional Patent App. No. 63/122,998, filed on Dec. 9, 2020, which is incorporated herein by reference in its entirety.

### FIELD

The present disclosure relates generally to the connection of floating devices, and more particularly, to a system, apparatus, and method for connecting floating devices.

### BACKGROUND

Flotation devices are frequently used for a variety of purposes, examples of which include safety, comfort, and convenience. While on water, flotation devices may be subject to the properties of the liquid in which they float. For instance, if a flotation device is in a river with a strong current, the flotation device may drift in accordance with the current. Often, flotation devices are connected to larger vessels or one another to counteract the properties of the water in which they float.

Existing methods for connecting flotation devices typically involve affixing a line or the like through one or more handholds of a given flotation device. While this may secure the flotation device, the se of line or the like alone may result in the flotation device behaving in unpredictable ways. For example, in some instances, the flotation device may float closer or farther from another vessel or flotation device than desired, depending on the length of the line used to secure the flotation device.

What is needed is an apparatus that connects a flotation device to another vessel or flotation device in a secure and predictable way.

### SUMMARY

In an example, a connection system for securing a flotation device is described. The system comprises a clamp configured to connect to the flotation device, a line length adjuster comprising a line, where the line length adjuster is configured to adjust a length of the line to a given length, and a connector configured to couple the clamp to the line length adjuster.

In some examples, the clamp comprises a single bolt clamp or a spring clamp.

In some examples, the given length is between 1 and 7 feet.

In some examples, the flotation device is a first flotation device, the clamp is a first clamp, where the line length adjuster is a first line length adjuster, where the connector is a first connector, and wherein the system further includes a second clamp, where the second clamp is configured to connect to a second flotation device, a second line length adjuster, where the second line length adjuster is configured to adjust the length of the line, where the line connects both the first line length adjuster and the second line length adjuster, and a second connector configured to couple the second clamp to the second line length adjuster.

In some examples, the connector is connected to the clamp and the line length adjuster.

In some examples, the line length adjuster is selected from the group consisting of a rope adjuster and a retractable pulley device.

In some examples, the system is a single unitary construction.

In another example, a connection system for securing a flotation device is described. The system comprises a clamp, wherein the clamp is configured to connect to the flotation device, and a line length adjuster comprising a line and connected to the clamp, wherein the line length adjuster is configured to adjust a length of the line to a given length.

In some examples, the given length is between 1 and 7 feet.

In some examples, the flotation device is a first flotation device, the clamp is a first clamp, and the line length adjuster is a first line length adjuster, and the system further comprises a second clamp, where the second clamp is configured to connect to a second flotation device, and a second line length adjuster, where the second line length adjuster is configured to adjust the length of the line, and where the line connects both the first line length adjuster and the second line length adjuster.

In some examples, the system is a single unitary construction.

In yet another example, a connection system for securing a flotation device is described. The system comprises a line comprising a first length of line and a second length of line, a first clamp that is connected to a first end of the first length of line, a second clamp that is connected to a first end of the second length of line, and a line length adjuster, where the line length adjuster is connected to a second end of the first length of line and a second end of the second length of line, and where the line length adjuster is configured to (i) adjust a length of the first length of line to a given first length and (ii) adjust a length of the second length of line to a given second length.

In some examples, the first clamp comprises a single bolt clamp, and wherein the second clamp comprises a single bolt clamp.

In some examples, the first clamp comprises a spring clamp, and the second clamp comprises a spring clamp.

In some examples, the line comprises a single line.

In some examples, the line comprises a first line and a second line, where the first line comprises the first length of the line and the second line comprises the second length of the line.

In some examples, the given first length is between 1 and 7 feet, and wherein the given second length is between 1 and 7 feet.

In some examples, the line length adjuster is configured to adjust the length of the first length of line to the given first length using a pulley.

In some examples, the line length adjuster is configured to adjust the length of the second length of line to the given second length using a pulley.

In some examples, the line length adjuster comprises a button configured to, upon activation, allow one or both of the first length of line and the second length of line to be extended or retracted.

In some examples, the system is unitary apparatus.

The features, functions, and advantages that have been discussed can be achieved independently in various examples or may be combined in yet other examples further details of which can be seen with reference to the following description and drawings.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying drawings, wherein:

FIG. 1 is an example connection system, according to an example implementation.

FIG. 2 is an example clamp, according to an example implementation.

FIG. 3 is an example line length adjuster, according to an example implementation.

FIG. 4 is an example connection system, according to an example implementation.

### DETAILED DESCRIPTION

Disclosed examples will now be described more fully hereinafter with reference to the accompanying drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

Within examples, apparatuses and systems for connecting flotation devices are described. More specifically, example apparatuses and systems connect flotation devices using at least one of a clamp, a connector, and/or a line length adjuster.

As previously discussed, flotation devices (e.g., tubes, rafts, lifesavers, etc.) may be connected to another vessel or to one another to secure them for various reasons, examples of which include safety (e.g., ensuring a safety flotation device is within reach of a potential user), leisure (e.g., ensuring two or more flotation devices remain near one another when floating), or sport (e.g., ensuring a flotation device remains attached to a vessel towing the flotation device). However, current apparatuses and methods for securing a given flotation device to another vessel or flotation device have various limitations, For instance, current apparatuses and methods for securing a given flotation device to another vessel or flotation device typically involve looping a line (e.g., a rope, string, or other cord) through handholds or the like of the flotation device. While this connection may ensure that the given flotation device does not drift away from the other vessel or flotation device, it is often inconvenient as the line may become tangled when the given flotation device drifts in different directions. Further, another example limitation of existing apparatuses and methods for securing a given flotation device to another vessel or flotation device is that not all flotation devices have a handhold that would allow a line to be passed through in order to secure it, thereby making it difficult to secure such a flotation device.

To help address the aforementioned and other problems, the example apparatuses and systems provide for a connection system that generally contains (i) a clamp that serves to affix the connection system to a given flotation device, (ii) a connector that serves to couple the clamp to the line length adjuster, and a (iii) a line length adjuster that serves to adjust the length of the line or other cord.

The use of the connection system may be beneficial as it enables the securing of a given flotation device to another vessel or flotation device at a desired distance that is adjustable based on the needs of the application. For instance, if there is a desire to secure a given flotation tightly to a vessel or other flotation device (e.g., for transportation), the line length adjuster can be used to shorten the amount of line securing the given flotation device. In contrast, if there is a desire to loosely secure the given flotation device to a vessel or other flotation device (e.g., for leisure), the line length adjuster can be used to lengthen the amount of line securing the given flotation device.

The particular configuration of the connection system can depend on the desired application and the type of flotation device. A number of example configurations of the connection system, as well as the various forms each of the clamp, connector, and line length adjuster may take are described herein.

The connection system described herein may take various forms. In one implementation, the connection system may include one or more separate devices that when arranged together serve to connect a given flotation device to another vessel or flotation device.

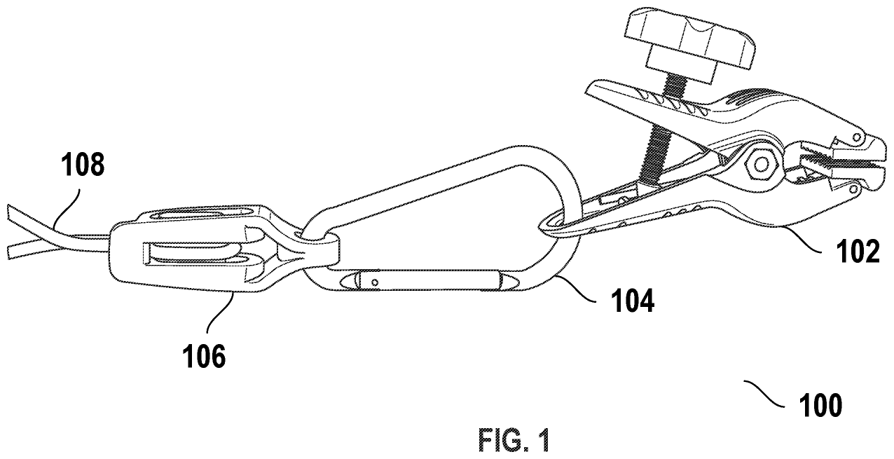

For instance, FIG. 1 illustrates an example connection system 100 that includes a clamp 102, a connector 104, a line length adjuster 106, and a line 108. As shown, the connector 104 is arranged in a hole of clamp 102 and a hole of line length adjuster 106 such that clamp 102 is attached, albeit indirectly, to line length adjuster 106.

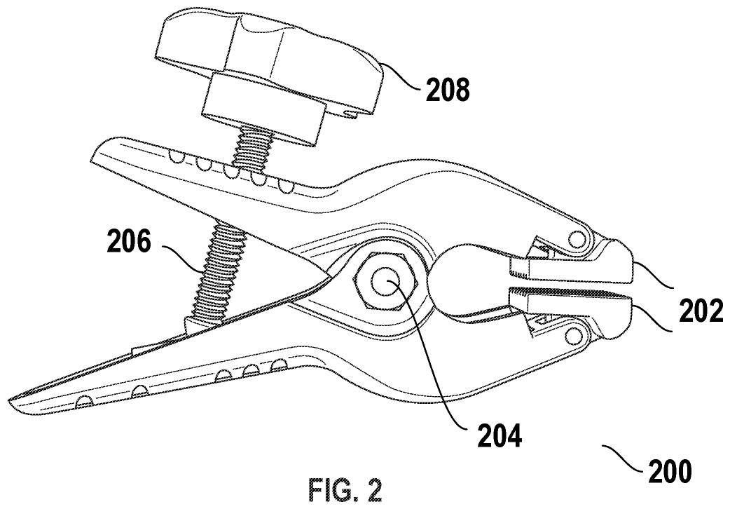

Clamp 102 may take various forms. As one possibility, clamp 102 may take the form of a single bolt clamp. For instance, FIG. 2 illustrates an example clamp 200 that takes the form of a single bolt clamp. As shown, clamp 200 includes jaws 202, hinge 204, bolt 206, and cap 208.

Jaws 202 may take various forms. In one example, jaws 202 may be flat such that when jaws 202 are closed around a flotation device there is no deformation of the flotation device. In another example, jaws 202 may be serrated such that, when jaws 202 are closed around a flotation device, jaws 202 deform the flotation device in a manner that provides additional grip on the flotation device. Further, in some examples, jaws 202 may be covered in a protective coating that serves to protect jaws 202 from wear as the clamp 200 is affixed to a flotation device. Jaws 202 may take other forms as well.

Hinge 204 may serve to allow jaws 202 of clamp 200 to easily open and close when bolt 206 is secured in place. In this respect, hinge 204 allows clamp 200 to be positioned around a given area of a flotation device prior to closing jaws 202.

Bolt 206 may take various forms, one example of which may include a screw that can extend through clamp 200. In this respect, bolt 206 serves to either allow jaws 202 to open or to force jaws 202 to remain closed depending on the desired effect. For instance, if bolt 206 is minimally extended through clamp 200, jaws 202 may be able to open and close freely. In contrast, if bolt 206 is fully extended through clamp 200, jaws 202 may be forced closed. Bolt 206 may take other forms as well.

Cap 208 may be affixed to one end of bolt 206 and may function to provide an individual the ability to easily extend bolt 206 through clamp 200. In practice, cap 208 may be textured or designed in such a way that allows a hand or the like to easily grip cap 208 in order to extend bolt 206 through clamp 200.

Turning back to FIG. 1, clamp 102 may take other forms as well, examples of which include a spring clamp, vice grip, screw clamp bar clamp, a clip, among others.

Further, clamp 102 may be made of various materials, examples of which include plastic, metal, rubber, or any combination thereof.

Connector 104 may take various forms. As one possibility, connector 104 may be a carabiner. In this respect, the carabiner may have a spring-loaded gate that, when pressure is applied, may function to open the gate to allow for the connector 104 to be connected to clamp 102 and line length adjuster 104.

As another possibility, connector 104 may be a key ring (e.g., multi-loop ring). In this respect, the key ring may have a plurality of loops such that when pressure is applied to separate the loops, one of the loops can be passed through a hole in the clamp 102 and/or line length adjuster 106 to connect the two. As yet another possibility, connector 104 may be a linking device configured to connect to clamp 102 and line length adjuster 104.

Connector 104 may take other forms as well.

Further, connector 104 may be made of various materials, examples of which include plastic, metal, rubber, or any combination thereof.

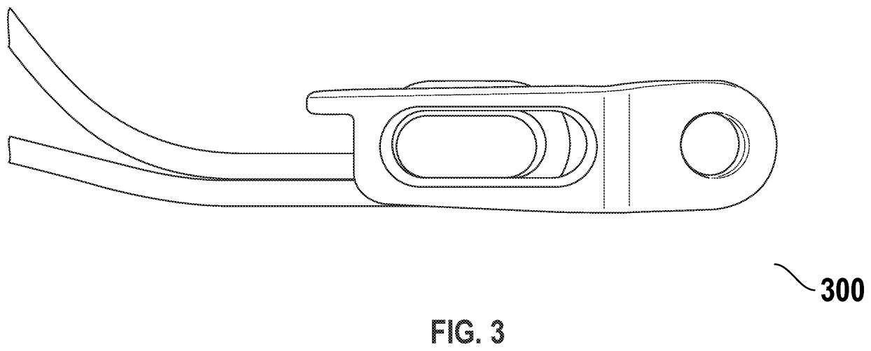

Line length adjuster 106 may take various forms, including any adjusting device configured to adjust the length of a line. As one possibility, FIG. 3 illustrates an example line length adjuster 300 that takes the form of a line length adjuster. As shown, line length adjuster 300 may include a series of cavities through which a line or equivalent material can pass through. In practice, a line can be passed through the series of cavities of line length adjuster 300 and then line length adjuster 300 can be slid along the line until a desired point along the line is reached. Then, the line can be pulled taut, which causes the line length adjuster 300 to be affixed to the line at the desired point along the line. In this respect, line length adjuster 300 can be used to lengthen or shorten the amount of line that extends between the given flotation device and another vessel or flotation device and couples a given flotation device to another vessel or flotation device.

Turning back to FIG. 1, line length adjuster 106 may take other forms, examples of which include tighteners and cinches, among other line length adjusting devices.

Further, line length adjuster 106 may be made of various materials, examples of which include plastic, metal, rubber, or any combination thereof.

Within examples, line 108 is a securing line and may take various forms, examples of which include a rope, cord, string, cable, line, or wire, among others. Further, line 108 may be made of various materials, including (i) natural materials such as hemp, linen, cotton, coir, jute, straw, and sisal, among others, and/or (ii) synthetic materials such as polypropylene, nylon, polyesters, polyethylene, and acrylics, among others.

In accordance with the present disclosure, a method for securing a flotation device (e.g., to another flotation device or vessel) is provided. In one example operation, an individual may first affix clamp 102 to a given flotation device. The individual may then connect clamp 102 to line length adjuster 106 using the connector 104. Next, the individual may pass line 108 through the line length adjuster 106 to achieve a desired line length. Finally, the individual may affix line 108 to another vessel, flotation device, or another connection system 100. The individual may affix line 108 to another vessel, flotation device, or another connection system in various ways. In one example, if affixing to another vessel, the individual may affix line 108 to another vessel by affixing line 108 to a cleat or other anchor on the vessel. In another example, if affixing to another flotation device through another connection system, the individual may pass line 108 through a line length adjuster of the other connection system, which in turn may be coupled to a clamp of the other connection system via a connector of the other connection system. Then, the individual may connect the clamp of the other connection system to the other flotation device. The individual may affix line 108 to another vessel, flotation device, or another connection system in other ways as well. It should be understood that the order in which the steps described in these example operations are completed may vary in other examples or applications.

In some examples, clamp 102 may be directly connected to line length adjuster 106 without connector 104. In such an example, one or both of clamp 102 and line length adjuster 106 may additionally be configured to connect to one another. In other examples, connector 104 may be incorporated into either clamp 102 or line length adjuster 106.

Connection system 100 having multiple components may be beneficial in that it allows each of the components to be swapped onto other connection systems. For instance, if a first clamp is connected to a first flotation device and a second clamp is connected to a second flotation device, an individual may be able to take the connector off of the first clamp and attach it to the second clamp.

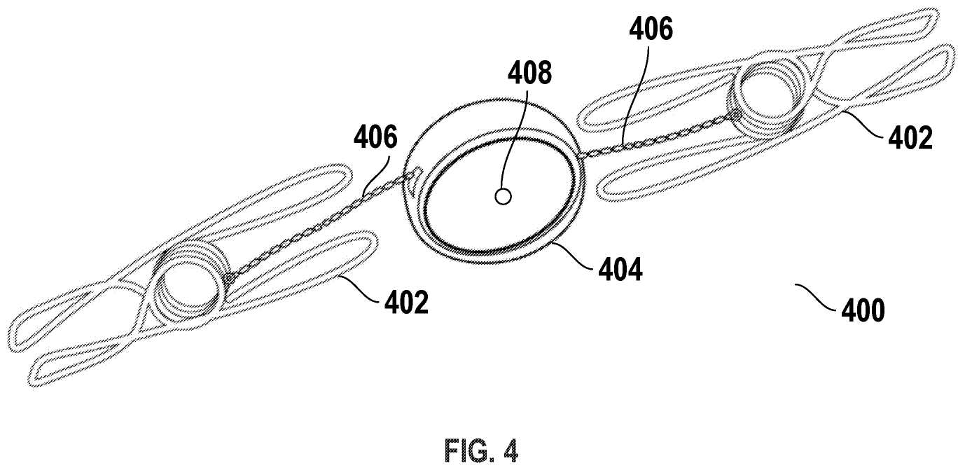

In another implementation, the connection system may be an apparatus that combines one or more of the clamp, connector, and/or line length adjuster into a single manufactured apparatus or unitary apparatus. For instance, FIG. 4 illustrates an example connection apparatus 400 that includes a pair of clamps 402, a line length adjuster 404, and one or more lines 406.

Clamps 402 may take various forms, such as the clamps illustrated in FIG. 4. Other example clamps 402 are possible as well, examples of which may include clamp 102 described above with respect to FIG. 1 and clamp 200 described above with respect to FIG. 2. Clamp 402 may take other forms as well.

Line length adjuster 404 may take various forms, one example of which includes a retractable pulley device, which is shown in FIG. 4. In this respect, line length adjuster 404 may be configured to, when force is applied (e.g., through pulling or pushing), allow one of lines 406 to extend away from the line length adjuster 404. Further, line length adjuster 404 may be configured to lock one of lines 406 in place when force is no longer applied to the line. As another example, line length adjuster 404 may optionally have a button 408 (or equivalent mechanism) that when pressed, allows one or both lines to be extended and/or retracted. Accordingly, line length adjuster 404 may allow an individual to extend one of lines 406 to the desired length and then stop applying pressure to keep the line at the desired length. In practice, the length to which each of the one or more lines can be extended may be between 1-7 feet, although other example lengths are possible as well.

Line length adjuster 404 may also be configured to retract lines 406 in various ways. As one example, line length adjuster 404 may retract one of lines 406 if pressure is applied (e.g., a pulling action is performed) to one of lines 406 when the line is already extended to its maximum length. As another example, line length adjuster 404 may have a button or equivalent mechanism that when pressed, retracts one or both of lines 406. Line length adjuster may be configured to retract one or more lines 406 in other ways as well. Line length adjuster 404 may take other forms as well, one example of which includes line length adjuster 106 described above with respect to FIG. 1.

One or more lines 406 may take various forms. As one possibility, one or more lines 406 may be a single line that passes through line length adjuster 404. In this respect, line length adjuster 404 may function to extend or retract one or both ends of the single line. As another possibility, one or more lines 406 may be two separate lines that pass through line adjuster 404. In this respect, line length adjuster 404 may function to extend or retract one or both of the two separate lines. One or more lines 406 may take other forms as well.

In an example operation, an individual may first affix one of clamps 402 to a given flotation device. The individual may then apply pressure to one of lines 406 to extend the line out of line length adjuster 404. When the desired length is reached, the individual may stop applying pressure to the line to lock the line at the desired length. Next, the individual may affix the other one of clamp 402 to another vessel or flotation device, which in turn may connect the given flotation device to other vessel or flotation device. It should be understood that the order in which the steps described in this example operation are completed may vary in other examples or applications.

The unitary nature of connection apparatus system 400 may be beneficial in that it allows a user secure a given flotation device to another vessel or flotation device using a single apparatus, which in turn may be easier to attach, use, and store.

Different examples of the system(s), device(s), and method(s) disclosed herein include a variety of components, features, and functionalities. It should be understood that the various examples of the system(s), device(s), and method(s) disclosed herein may include any of the components, features, and functionalities of any of the other examples of the system(s), device(s), and method(s) disclosed herein in any combination or any sub-combination, and all of such possibilities are intended to be within the scope of the disclosure.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to best explain the principles of the examples, the practical application, and to enable others of ordinary skill in the art to understand the disclosure for various examples with various modifications as are suited to the particular use contemplated.

What is claimed is:

1. A system for securing a flotation device, the system comprising:
a clamp configured to connect to the flotation device;
a line length adjuster comprising a line, wherein the line length adjuster is configured to adjust a length of the line to a given length; and
a connector configured to couple the clamp to the line length adjuster.

2. The system of claim 1, wherein the clamp comprises a single bolt clamp or a spring clamp.

3. The system of claim 1, wherein the given length is between 1 and 7 feet.

4. The system of claim 1, wherein the flotation device is a first flotation device, the clamp is a first clamp, wherein the line length adjuster is a first line length adjuster, wherein the connector is a first connector, and wherein the system further comprises:
a second clamp, wherein the second clamp is configured to connect to a second flotation device;
a second line length adjuster, wherein the second line length adjuster is configured to adjust the length of the line, wherein the line connects both the first line length adjuster and the second line length adjuster; and
a second connector configured to couple the second clamp to the second line length adjuster.

5. The system of claim 1, wherein the connector is connected to the clamp and the line length adjuster.

6. The system of claim 1, wherein the line length adjuster is selected from the group consisting of a rope adjuster and a retractable pulley device.

7. The system of claim 1, wherein the system is a single unitary construction.

8. A system for securing a flotation device, the system comprising:
a clamp, wherein the clamp is configured to connect to the flotation device; and
a line length adjuster comprising a line and connected to the clamp, wherein the line length adjuster is configured to adjust a length of the line to a given length.

9. The system of claim 8, wherein the clamp comprises a single bolt clamp or a spring clamp.

10. The system of claim 8, wherein the given length is between 1 and 7 feet.

11. The system of claim 8, wherein the flotation device is a first flotation device, the clamp is a first clamp, and the line length adjuster is a first line length adjuster, and wherein the system further comprises:
a second clamp, wherein the second clamp is configured to connect to a second flotation device; and
a second line length adjuster, wherein the second line length adjuster is configured to adjust the length of the line, and wherein the line connects both the first line length adjuster and the second line length adjuster.

12. The system of claim 8, wherein the system is a single unitary construction.

13. A system for securing a flotation device, comprising:
a line comprising a first length of line and a second length of line;
a first clamp that is connected to a first end of the first length of line;
a second clamp that is connected to a first end of the second length of line; and
a line length adjuster, wherein the line length adjuster is connected to a second end of the first length of line and a second end of the second length of line, and wherein the line length adjuster is configured to (i) adjust a length of the first length of line to a given first length and (ii) adjust a length of the second length of line to a given second length.

14. The system of claim 13, wherein the first clamp comprises a single bolt clamp, and wherein the second clamp comprises a single bolt clamp.

15. The system of claim 13, wherein the first clamp comprises a spring clamp, and wherein the second clamp comprises a spring clamp.

16. The system of claim 13, wherein the line comprises a single line.

17. The system of claim 13, wherein the line comprises a first line and a second line, wherein the first line comprises the first length of the line and the second line comprises the second length of the line.

18. The system of claim 13, wherein the line length adjuster is configured to adjust the length of the first length of line to the given first length using a pulley, and wherein the line length adjuster is configured to adjust the length of the second length of line to the given second length using a pulley.

19. The system of claim 13, wherein the line length adjuster comprises a button configured to, upon activation, allow one or both of the first length of line and the second length of line to be extended or retracted.

20. The system of claim 13, wherein the system is unitary apparatus.
